(19) United States
(12) Patent Application Publication
(10) Pub. No.: US 2009/0213100 A1
(43) Pub. Date: Aug. 27, 2009

(54) ELECTRO-OPTICAL DEVICE, METHOD OF DRIVING ELECTRO-OPTICAL DEVICE, AND ELECTRONIC APPARATUS

(75) Inventors: Kenya WATANABE, Suwa-shi (JP); Ryo Ishii, Matsumoto-shi (JP)

Correspondence Address: LOWE HAUPTMAN HAM & BERNER, LLP, 1700 DIAGONAL ROAD, SUITE 300, ALEXANDRIA, VA, 22314, US

(73) Assignee: Seiko Epson Corporation, Tokyo (JP)

(21) Appl. No.: 12/370,028

(22) Filed: Feb. 12, 2009

(30) Foreign Application Priority Data
Feb. 26, 2008 (JP) 2008-044546

(51) Int. Cl. G09G 5/00; G09G 3/36

(52) U.S. Cl. 345/205; 345/98

(57) ABSTRACT

An electro-optical device includes n (n is an integer of 2 or more) main scan lines; m (m is an integer of 1 or more) sub scan lines provided in correspondence with a k-th main scan line (1≦k≦n) of the n main scan lines; m logic circuits provided between the k-th main scan line and the m sub scan lines; a plurality of pixel circuits respectively connected to the m sub scan lines; and a scan line driving circuit selecting the n main scan lines, wherein the k-th main scan lines has a set of x (x is an integer of 2 or more) main scan line selection signal delivery lines, each of the set of x main scan line selection signal delivery lines configuring the k-th main scan line is selected by each of first to x-th main scan line selection signals having the same period and different phases and output from the scan line driving circuit, and each of the m logic circuits has x input nodes, each of the x input nodes is connected to each of the set of x main scan line selection signal delivery lines, and each of the m sub scan lines is selected on the basis of each of the output signals of the m logic circuits.

### BACKGROUND

1. Technical Field

The present invention relates to an electro-optical device (for example, a liquid crystal display device), a method of driving the electro-optical device, and an electronic apparatus.

2. Related Art

For example, in a liquid crystal display device using a digital driving method (a driving method of dividing one field into a plurality of subfields and driving the subfields by digital signals), in order to realize multi-gradation, more subfields are necessary. In this case, scan lines need to be more rapidly driven and thus the selection periods of the scan lines shorten.

However, if the selection periods of the scan lines shorten, a possibility of occurrence of double selection (simultaneous selection of adjacent scan lines) is increased. An example of a countermeasure against the double selection is, for example, disclosed in JP-A-2001-166744. In JP-A-2001-166744, a NOR logic operation is performed with respect to the outputs of adjacent shift registers, for the purpose of preventing overlapping of output signals (scan line signals or data line signals) from shift registers circuits with respect to a scan line (data line) driving circuit using shift registers.

In addition, if one scan line lengthens, signal delay occurs and the possibility of the double selection is increased. Accordingly, if one scan line excessively lengthens, the length of the scan lines may shorten by dividing the scan line into a plurality of scan lines. In this case, it is necessary to decode scan line driving signals and generate driving signals corresponding to the plurality of scan lines divided. A similar technique (subrow decode method) is, for example, disclosed in JP-T-2002-508525.

In order to realize high speed driving of the scan lines in an electro-optical device (for example, a liquid crystal display device), for example, the following problems occur.

For example, in a liquid crystal display device (a liquid crystal display panel requiring 1920×1080 or more pixels) corresponding to a full HD (a method using 1080 or more scan lines of high-definition digital TV (HDTV) broadcasts), since the lengths of the scan lines and the number of pixel circuits connected to the scan lines are increased, a scan line load is extremely increased. If the scan line load is large, the following problems occur.

That is, scan line charging/discharging current of the scan line driving circuit is increased and thus the line width of a power supply supplied to the scan line driving circuit is increased. The area of the scan line driving circuit is increased. Peak noise is susceptible to occur. If a newest pixel circuit using a memory (a flip-flop or the like) is used instead of retentive capacity, malfunction of the circuit may occur.

In addition, waveform dullness of the scan line signal occurs. Accordingly, an actual scan line selection period (a period of fixing the potential of the scan line) is reduced. If a writing time to the pixel circuit is decreased, double selection of scan lines occurs. That is, a scan line which is selected next rises before a scan line which is previously selected falls such that both of the two adjacent scan lines are temporarily selected. If the double selection of the scan lines occurs, for example, erroneous writing to the pixel circuit occurs. That is, right data is not written to the pixel circuit connected to the selected scan line so as to have a bad influence on display characteristics. In order to prevent the double selection, a countermeasure such as provision of a reset unit of the scan lines is separately necessary. That is, in the case where adjacent scan lines are line-sequentially driven, a reset unit for intentionally providing a reset period in which both of the two scan lines become a non-selection level is necessary between the selection periods of the two adjacent scan lines.

The operation of the scan line driving circuit becomes complicated if the reset unit is provided in the scan line driving circuit and thus the high speed driving of the scan lines is restricted. In addition, the burden of the scan line driving circuit is increased and power consumption is increased due to the complication of the circuit.

Even when the technique disclosed in JP-A-2001-166744 is employed, if the scan line load is sufficiently large, waveform dullness of the scan line driving signal may occur and the double selection of the scan lines may occur. In addition, if the technique disclosed in JP-T-2002-508525 is employed, it is difficult to realize high speed driving of the scan lines. That is, in order to generate the subrow decode signal, since an input load such as an AND circuit is added to each scan line, the load of each scan line is increased. Accordingly, this technique is not suitable for the purpose of high-speed writing to pixels. For example, in a digital driving method capable of realizing high gradation, since more subfields are necessary, the sufficient high-speed writing to the pixels is of importance. Thus, the technique disclosed in JP-T-2002-508525 is not suitable for the liquid crystal display device using the digital driving method.

### SUMMARY

An advantage of some aspects of the invention is that high speed driving of scan lines is realized and power consumption of a scan line driving circuit is suppressed while double selection of adjacent scan lines is prevented with certainty.

According to an aspect of the invention, there is provided an electro-optical device including: n (n is an integer of 2 or more) main scan lines; m (m is an integer of 1 or more) sub scan lines provided in correspondence with a k-th main scan line (1≦k≦n) of the n main scan lines; m logic circuits provided between the k-th main scan line and the m sub scan lines; a plurality of pixel circuits respectively connected to the m sub scan lines; and a scan line driving circuit selecting the n main scan lines, wherein the k-th main scan line has a set of x (x is an integer of 2 or more) main scan line selection signal delivery lines, each of the set of x main scan line selection signal delivery lines configuring the k-th main scan line is selected by each of first to x-th main scan line selection signals having the same period and different phases and output from the scan line driving circuit, and each of the m logic circuits has x input nodes, each of the x input nodes is connected to each of the set of x main scan line selection signal delivery lines, and each of the m sub scan lines is selected on the basis of each of the output signals of the m logic circuits.

In the present aspect, since the scan lines are layered such that the main scan lines and the sub scan lines are provided and the logic circuits having the waveform shaping function are provided between the both lines, it is possible to prevent malfunction of the pixel circuits. The main scan lines include at least two scan line selection signal delivery lines. That is, although the signal waveform becomes dull in the portions of the scan line selection signal delivery lines located before the logic circuits, the waveform shaping is performed by the logic circuits and thus signals close to rectangular signals are given to the pixel circuits. Since the signals close to the rectangular signals are given to the pixel circuits, it is possible to prevent the malfunction of the flip-flop circuits in the pixels. In addition, for example, it is possible to reduce through-current (current flowing when a PMOS transistor and an NMOS transistor are simultaneously turned on) in an inverter circuit portion.

Since the main scan lines are configured by the plurality of main scan line selection signal delivery lines and the phase difference (the timing difference or the delay difference) of the main scan line selection signals supplied to the plurality of main scan line selection signal delivery lines are adjusted, a writing time necessary for writing data to the pixel circuits are freely set. The reset period can be freely provided.

That is, each of the plurality of input nodes of one logic circuit is connected to each of the set of main scan line selection signal delivery lines. The output level of the logic circuit (that is, the selection period of the sub scan line corresponding to the logic circuit) is determined by a combination of the voltage levels of the input nodes of the logic circuit. The combination of the voltage levels of the input nodes of the logic circuit is determined by the phase difference (the timing difference or the delay difference) of the selection signals between the set of main scan line selection signal delivery lines. Accordingly, the selection period of the sub scan line (that is, the writing period (or the reset period) of one pixel) is determined by the “phase difference” (the timing difference or the delay difference).

The parasitic loads of the plurality of main scan line selection signal delivery lines are substantially equal. For example, if the main scan line is configured by two (that is, a set of two) main scan line selection signal delivery lines and the selection signal of one scan line selection signal delivery line is delayed, the selection signal of the other scan line selection signal delivery line is delayed. Accordingly, the phase difference (the timing difference or the delay difference) between the selection signals of the both scan line selection signal delivery lines is constant regardless of the distance from the scan line driving circuit. Thus, the selection time of a certain pixel circuit may be set regardless of the distance from the scan line driving circuit. Accordingly, even when the length of the main scan line lengthens or even when the main scan line needs to be driven with high speed, accurate control of the selection period (or the reset period) of the pixel circuit is possible.

The operation timing of the selection signal of each of the sub scan lines for setting the pixel circuits to a selection/non-selection state is determined by the rising or falling timing of each of the main scan line selection signals. By adjusting the phase difference between the main scan line selection signals, it is possible to freely control the timing. Accordingly, as described above, it is possible to freely set the reset period. The reset period is intentionally provided between the selection period of at least one sub scan line belonging to the k-th main scan line and the selection period of at least one sub scan line belonging to the (k+1)-th main scan line, and is a period in which both the sub scan lines are not selected. By providing the reset period, it is possible to prevent double selection (at least one sub scan line belonging to each of the adjacent main scan lines is simultaneously selected) even when delay occurs in the driving of the sub scan line.

In addition, it is easy to set setup/hold time of the written data to each of the pixel circuits. Since each of the pixel circuits is in the non-selection state at a period excluding the rising or falling timing of each of the main scan line selection signals (that is, a state in which the voltage level of the main scan line selection signal is not changed and is maintained at a predetermined level), it is difficult to perform an operation, such as rewriting, by the pixel circuits several times due to unnecessary data. That is, the pixel circuits are connected to the sub scan lines and the logic circuits are provided between the sub scan lines and the main scan lines, the pixel circuits are not influenced by external disturbance.

In addition, since the plurality (2 or more) of pixel circuits is connected to the sub scan lines selected by the outputs of the logic circuits, the load of each of the scan lines is reduced from the viewpoint of the scan line driving circuit. That is, the plurality of pixels is connected to each of the scan lines in the related art. Accordingly, from the viewpoint of the scan line driving circuit, the pixels function as the load. In contrast, in the present embodiment, since the logic circuits are provided, the logic circuits function as the load from the viewpoint of the scan line driving circuit. If the plurality (for example, w) of pixels is driven by the logic circuits, the load is reduced to 1/w by simple computation from the viewpoint of the scan line driving circuit. Accordingly, it is possible to realize the high-speed frequency (rising speed and falling speed) of each of the main scan line selection signals.

In addition, as described above, in the present aspect, the reset period may be automatically inserted by controlling the timings of the input signals of the logic circuits. Accordingly, the reset unit does not need to be inserted into the scan line driving circuit and the circuit configuration of the scan line driving circuit does not become complicated. Accordingly, higher-speed scan line driving is possible. In addition, since the internal load of the scan line driving circuit is not increased, charging/discharging current of the scan line driving circuit portion is reduced and thus power consumption is reduced.

The scan line driving circuit may line-sequentially drive the n main scan lines without using a circuit for preventing simultaneous selection of adjacent main scan lines.

According to the present aspect, the reset period is automatically set according to the phase difference (the timing difference or the delay difference) of the plurality of main scan line selection signals when the selection signals of the sub scan lines (the output signals of the logic circuits) are generated. Accordingly, the reset unit does not need to be provided in the scan line driving circuit. Thus, the circuit configuration does not become complicated, and higher-speed scan line driving is possible. In addition, since the internal load of the scan line driving circuit is not increased, the charging/discharging current of the scan line driving circuit portion is reduced and thus power consumption is reduced.

When the k-th main scan line and a (k+1)-th main scan line are line-sequentially driven, between a selection period of a p-th (1≦p≦m) of the m sub scan lines corresponding to the k-th main scan line and a selection period of a q-th (1≦q≦m) of the m sub scan lines corresponding to the (k+1)-th main scan line, a reset period in which both the p-th sub scan line and the q-th sub scan line become a non-selection level may be provided, and the length of the reset period or the selection period of the sub scan line may be determined by a phase difference between each of the second to x-th main scan line selection signals and the first main scan line selection signal among the first to x-th main scan line selection signals.

As described above, each of the main scan lines is configured by the plurality of main scan line selection signal delivery lines and the phase difference (the timing difference and the delay difference) of the main scan line selection signals supplied to the plurality of main scan line selection signal delivery lines is adjusted, such that the writing time necessary for the writing of the data to the pixel circuits is freely set. In addition, the reset period can be freely set. Since the parasitic loads of the main scan line selection signal delivery lines are substantially equal, the selection time of a certain pixel circuit may be set regardless of the distance from the scan line driving circuit. Accordingly, accurate control of the selection period (or the reset period) is possible.

When a phase difference relationship between each of the second to x-th main scan line selection signals and the first main scan line selection signal among the first to x-th main scan line selection signals of the k-th main scan line is a first phase difference relationship and a phase difference relationship between each of the second to x-th main scan line selection signals and the first main scan line selection signal among the first to x-th main scan line selection signals of an r-th (1≦r≦n and r≠k) main scan line is a second phase difference relationship, the scan line driving circuit may generate the first to x-th main scan line selection signals of the k-th main scan line and the first to x-th main scan line selection signals of the r-th main scan line such that the first phase difference relationship and the second phase difference relationship are different from each other.

In the present aspect, the plural kinds of main scan line selection signals (the main scan line selection signals having different timings, that is, the main scan line selection signals having different phase relationships) are prepared as the main scan line selection signals. These main scan line selection signals are selectively used according to the pixel circuits. In the present aspect, among all the pixel circuits existing in the display area of the liquid crystal display device, for example, the first group is driven at the first timing (the first selection period or the first reset period) and the second group is driven at the second timing (the second selection period or the second reset period) different from the first timing. Accordingly, it is possible to set the writing time to the pixel circuits to an optimal time. Even when the present aspect is used, the above-described effect can be obtained.

The plurality of logic circuits connected to each of the n main scan lines may include a first kind of logic circuit which performs a first logic operation and a second kind of logic circuit which performs a second logic operation which is an inverted logic operation of the first logic operation.

If the positive/negative signal is necessary as the signal supplied to each of the pixel circuits, for example, the output of the logic circuit is inverted by an inverter. That is, if a NOR gate is used as the logic circuit, the NOR gate may be changed to an OR gate with respect to a pixel circuit requiring the negative selection signal. Accordingly, the complementary signals of H/L may be readily used as the selection signals of the pixel circuits.

When at least one sub scan line close to the scan line driving circuit is a short-range sub scan line and at least one sub scan line farther from the scan line driving circuit than the short-range sub scan line is a long-range sub scan line, among the m sub scan lines provided in correspondence with the k-th main scan line (1≦k≦n), i (i is an integer of 3 or more) pixel circuits may be connected to the short-range sub scan line and j (j is an integer of 2 or more and j<i) pixel circuits may be connected to the long-range sub scan line.

While waveform dullness of the main scan line selection signals of the pixel circuits arranged at the position close to the output terminal of the scan line driving circuit is reduced and a normal timing thereof is maintained, waveform dullness of the main scan line selection signals of the pixel circuits arranged at the position far from the scan line driving circuit is increased by the increase in the length of the main scan line and the load and a level change timing thereof is delayed relative to the normal timing. That is, strictly speaking, a slight difference occurs between the selection timings (driving timings) of the pixel circuits according to the distance from the scan line driving circuit. This timing difference can be reduced by employing a method of changing the number of pixel circuits connected to the logic circuit according to the distance from the scan line driving circuit (a method of intentionally changing the fan-out of the logic circuit). That is, the number of pixel circuits connected to the logic circuit arranged at the position close to the scan line driving circuit is set to be large such that the waveform of the selection signal of the sub scan line can become dull to some extent. In contrast, the number of pixel circuits connected to the logic circuit arranged at the position far from the scan line driving circuit is set to be small such that the waveform dullness of the selection signal of the sub scan line can be reduced. Accordingly, both the pixel circuit arranged at the position close to the scan line driving circuit and the pixel circuit arranged at the position far from the scan line driving circuit can be in the selection/non-selection state at substantially close timings. Accordingly, the display characteristics can be improved.

The scan line driving circuit may have first to x-th shift registers which generate the first to x-th main scan line selection signals having the same period and the different phases, and the first to x-th shift registers may operate by operation clocks having different phases.

If the plurality of dedicated shift register circuits is provided in order to generate the scan line selection signals supplied to the plurality of scan line selection signal delivery lines, the phases of the operation clocks for operating the shift register circuits are delayed by necessary delay time such that the selection times of the pixel circuits necessary for writing the data to the pixel circuits are freely and readily set.

According to another aspect of the invention, there is provided a method of driving an electro-optical device including n (n is an integer of 2 or more) main scan lines, m (m is an integer of 1 or more) sub scan lines provided in correspondence with a k-th main scan line (1≦k≦n) of the n main scan lines, m logic circuits provided between the k-th main scan line and the m sub scan lines, a plurality of pixel circuits respectively connected to the m sub scan lines, and a scan line driving circuit selecting the n main scan lines, wherein the k-th main scan lines has a set of x (x is an integer of 2 or more) main scan line selection signal delivery lines, and each of the m logic circuits has x input nodes, each of the x input nodes is connected to each of the set of x main scan line selection signal delivery lines, and each of the m sub scan lines is selected on the basis of each of the output signals of the m logic circuits, wherein each of the set of x main scan line selection signal delivery lines configuring the k-th main scan line is selected by each of first to x-th main scan line selection signals having the same period and different phases and output from the scan line driving circuit.

According to the present aspect, it is possible to realize high-speed scan line driving and suppress the power consumption of the scan line driving circuit, while the double selection of the adjacent scan lines are prevented with certainty.

An electronic apparatus of the invention includes the above-described electro-optical device.

The electronic apparatus of the invention can realize high-quality display because the display characteristics are improved by the layering of the scan lines. Accordingly, the display performance of the electronic apparatus (for example, the mobile telephone having a liquid crystal display panel mounted therein) having the electro-optical device mounted therein is also improved.

According to the several embodiments of the invention, for example, it is possible to realize high-speed scan line driving and suppress the power consumption of the scan line driving circuit, while the double selection of the adjacent scan lines are prevented with certainty.

### BRIEF DESCRIPTION OF THE DRAWINGS

The invention will be described with reference to the accompanying drawings, wherein like numbers reference like elements.

FIG. 1 is a view showing an example of the configuration of an electro-optical device (a liquid crystal display device) of the invention.

FIGS. 2A to 2C are views explaining a detailed example of the internal configuration of a scan line driving circuit.

FIGS. 3A and 3B are views showing a case where a selection period (a writing period or a reset period) of each of pixel circuits is controlled using a phase difference between two main scan line selection signals.

FIG. 4 is a waveform diagram showing the waveforms of the main operations when the main scan line selection signals shown in FIG. 3A are used, in the liquid crystal display device of FIG. 1.

FIG. 5 is a waveform diagram showing the waveforms of the main operations when the main scan line selection signals shown in FIG. 3B are used, in the liquid crystal display device of FIG. 1.

FIG. 6 is a view showing the configuration of another example of the electro-optical device (a liquid crystal display device) of the invention.

FIG. 7 is a view explaining plural kinds of scan line selection signals used in the circuit of FIG. 6.

FIG. 8 is a view explaining an example of selectively using plural kinds of logic circuits.

FIG. 9 is a view explaining an example of changing the number of pixel circuits connected to a sub scan line according to the distance from the scan line driving circuit.

FIG. 10 is a perspective view showing the appearance of an example (mobile telephone) of an electronic apparatus including the liquid crystal display device of the invention.

### DESCRIPTION OF EXEMPLARY EMBODIMENTS

Next, embodiments of the invention will be described with reference to the accompanying drawings. The following embodiments do not restrict the contents of the invention described in claims and all the configurations described in the present embodiments are not necessary as solving means of the invention.

### First Embodiment

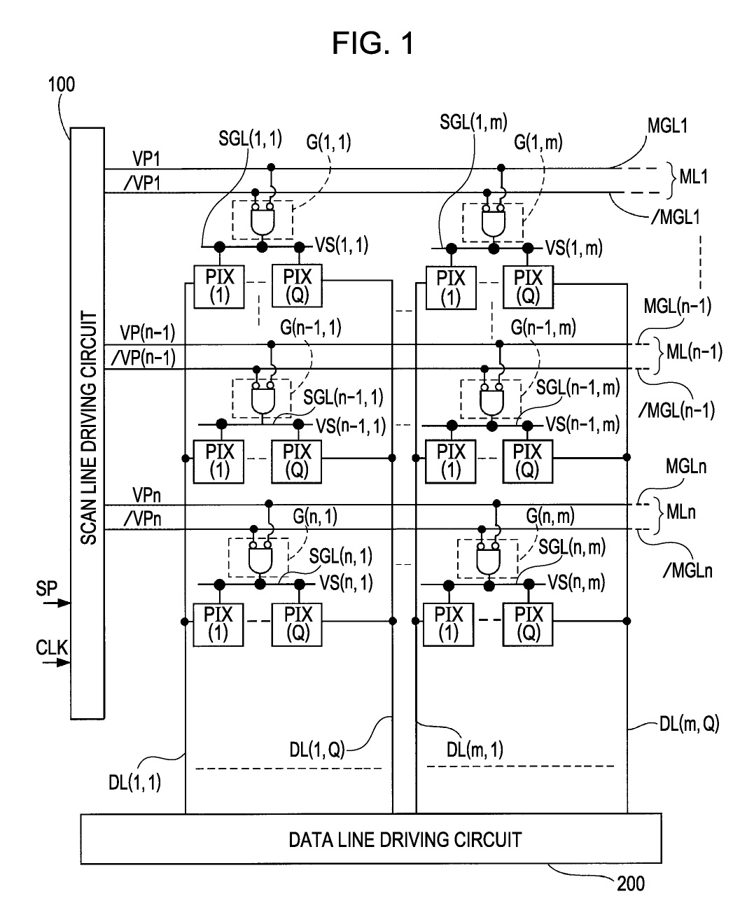

FIG. 1 is a view showing an example of the configuration of an electro-optical device (a liquid crystal display device) of the invention. The liquid crystal display device of FIG. 1 is a liquid crystal display device using a digital driving method (for example, a subfield driving method of dividing one field into a plurality of subfields and driving the subfields by digital signals). In order to realize a multi-gradation display with high precision, more subfields need to be driven with a higher speed.

In the related art, the possibility of double selection is increased by the high-speed scan line selection. In contrast, in the present embodiment, it is possible to realize high speed driving of scan lines and suppress power consumption of a scan line driving circuit while double selection of adjacent scan lines is prevented with certainty, by employing a novel configuration. Hereinafter, the embodiment will be described in detail.

In the liquid crystal display device of FIG. 1, the novel configuration in which scan lines are layered, main scan lines ML (ML1 to MLn) and sub scan lines SGL (SGL(1,1) to SGL(n,m)) are provided, and logic circuits (G(1,1) to G(n,m)) having a waveform shaping function is provided between the main scan lines and the sub scan lines is employed. Here, n and m are integers of 1 or more. In addition, each of the sub scan lines is locally provided in an image display area and thus may be called a local scan line.

In FIG. 1, a reference numeral 100 denotes the scan line driving circuit, 200 denotes a data line driving circuit, ML (ML1 to MLn) denote the main scan lines, and SGL (SGL(1,1) to SGL(n,m) denote the sub scan lines. In addition, each of the main scan lines ML (ML1 to MLn) is configured by a set of two scan line selection signal delivery lines (MGL1, /MGL1 to MGLn, /MGLn).

Each of the set of the two main scan line selection signal delivery lines (MGL1, /MGL1 to MGLn, /MGLn) is driven by each of main scan line selection signals VP1, /VP1 to VPn, /VPn.

Each of the logic circuits (G(1,1) to G(n,m)) is composed of a NOR gate circuit (this is only exemplary and the invention is not limited to this). In addition, each of the sub scan lines SGL(1,1) to SGL(n,m) is connected with Q (Q is an integer of 2 or more) pixel circuits PIX(1) to PIX(Q). That is, one sub scan line is connected with a plurality of pixels PIX(1) to PIX(Q).

Image data output from the data line driving circuit 200 is supplied to the pixel circuits PIX(1) to PIX(Q) via data lines DL(1,1) to DL(m,Q). Each of the pixel circuits PIX(1) to PIX(Q) includes a pixel transistor (not shown) of which the gate is connected to the sub scan line and the source is connected to the data line, and a memory circuit (a flip-flop, a RAM, or only a retentive capacity in case of a DRAM type pixel circuit; not shown) provided between the drain of the pixel transistor and a pixel electrode. The pixel electrode is, for example, connected with liquid crystal. Each of the pixel circuits PIX(1) to PIX(Q) are selected when any one of the sub scan lines SGL(1,1) to SGL(n,m) is active. For example, the image data of each of the Q pixel circuits PIX(1) to PIX(Q) connected to the common sub scan line is collectively rewritten (However, the invention is not limited to this).

In addition, the scan line driving circuit 100 has, for example, plural kinds of shift registers therein. Each of the shift registers operates, for example, using a start pulse SP and an operation clock CLK.

In addition, the main scan line selection signals VP1, /VP1 to VPn, /VPn are equal in a period and different in a phase (timing or delay amount). The set of two main scan line selection signals VP, /VP (VP1, /VP1 to VPn, /VPn) are equal in the generation period since the plurality of main scan lines ML1 to MLn are periodically driven in sequence. The main scan line selection signals are different in the phase (the change timing of the voltage level). The selection period (writing period) or the reset periods (the period in which all the sub scan lines become a non-selection level in the case where adjacent sub scan lines are sequentially driven) of the sub scan line can be freely adjusted by adjusting the timing difference.

That is, the liquid crystal display device of FIG. 1 includes the plurality of main scan lines ML1 to MLn, one or more sub scan lines SGL(1,1) to SGL(n,m) provided in correspondence with one main scan line, the logic circuits (G(1,1) to G(n,m)) provided between the main scan lines and the sub scan lines, the plurality of pixel circuits PIX1 to PIXQ connected to the sub scan lines, and the scan line driving circuit (scan line driver) 100 for selecting the main scan lines. Each of the plurality (n) of main scan lines ML1 to MLn has a set of plurality (for example, 2) of main scan line selection signal delivery lines MGL1, /MGL1 to MGLn, /MGLn.

Each of the set of the plurality of main scan line selection signal delivery lines MGL1, /MGL1 to MGLn, /MGLn configuring one main scan line is selected by each of the plurality of main scan line selection signals VP1, /VP1 to VPn, /VPn which are output from the scan line driving circuit 100 and equal in the period and different in the phase.

Each of the logic circuits (G(1,1) to G(n,m)) has a plurality (for example, 2) of input nodes, each of the plurality of input nodes is respectively connected to the plurality of main scan line selection signal delivery lines MGL1, /MGL1 to MGLn, /MGLn, and each of the plurality of sub scan lines SGL(1,1) to SGL(n,m) is selected on the basis of each of the output signals VS(1,1) to VS(n,m) of the plurality of logic circuits (G(1,1) to G(n,m)).

In the present embodiment, the scan lines are layered such that the main scan lines and the sub scan lines are provided and the logic circuits having the waveform shaping function are provided between the both scan lines, thereby preventing malfunction of the pixel circuit. That is, although signal waveforms become dull in the portions of the scan line selection signal delivery lines located before the logic circuits, since the waveform shaping is performed in the output portions of the logic circuits, signals close to rectangular signals are given to the pixel circuits. Since the signals close to the rectangular signals are given to the pixel circuits, for example, it is possible to prevent the malfunction of the flip-flop circuits in the pixels. In addition, it is possible to reduce through-current in an inverter circuit portion.

In addition, since the main scan lines are configured by the plurality of main scan line selection signal delivery lines and a phase difference (a timing difference or a delay difference) of the main scan line selection signals supplied to the plurality of main scan line selection signal delivery lines are adjusted, a writing time necessary for writing data to the pixel circuits are freely set. In addition, the reset period can be freely set. Since the parasitic loads of the main scan line selection signal delivery lines are substantially equal, the selection time of a certain pixel circuit may be set regardless of the distance from the scan line driving circuit. Accordingly, accurate control of the selection period (or the reset period) is possible.

In addition, the operation timing of the selection signal of each of the sub scan lines for setting the pixel circuits to a selection/non-selection state is determined by the rising or falling timing of each of the main scan line selection signals. By adjusting the phase difference between the main scan line selection signals, it is possible to freely control the timing. Accordingly, it is possible to freely control the reset period. In addition, it is easy to set setup/hold time of the written data to each of the pixel circuits. Since each of the pixel circuits is in the non-selection state at a timing excluding the rising or falling timing of each of the main scan line selection signals, it is difficult to perform the operation, such as rewriting, by the pixel circuits several times due to unnecessary data.

In addition, since the plurality (2 or more) of pixel circuits is connected to the sub scan lines selected by the outputs of the logic circuits, the load of each of the scan lines is reduced from the viewpoint of the scan line driving circuit. That is, the plurality of pixels is connected to each of the scan lines in the related art. Accordingly, from the viewpoint of the scan line driving circuit, the pixels function as the load. In contrast, in the present embodiment, since the logic circuits are provided, the logic circuits function as the load from the viewpoint of the scan line driving circuit. If the plurality (w) of pixels is driven by the logic circuits, the load is reduced to 1/w by simple computation from the viewpoint of the scan line driving circuit. Accordingly, it is possible to realize the high-speed frequency (rising speed and falling speed) of each of the main scan line selection signals.

Since the reset period does not need to be inserted into each of the scan line selection signals in the scan line driving circuit, higher-speed scan line driving is possible. In addition, since the internal load of the scan line driving circuit is not increased, charging/discharging current of the scan line driving circuit portion is reduced and thus power consumption is reduced.

In addition, as described above, the reset period is automatically set according to the phase difference (the timing difference or the delay difference) of the plurality of main scan line selection signals VP1, /VP1 to VPn, /VPn when the selection signals of the sub scan lines SGL(1,1) to SGL(n,m) (that is, the output signals VS(1,1) to VS(n,m) of the logic circuits (G(1,1) to G(n,m))) are generated. Accordingly, the reset circuit does not need to be provided in the scan line driving circuit 100 like in the related art, the circuit configuration does not become complicated, and higher-speed scan line driving is possible. In addition, the internal load of the scan line driving circuit 100 is not increased, the charging/discharging current in the scan line driving circuit 100 is reduced and thus power consumption is reduced.

In addition, as described above, each of the main scan lines ML1 to MLn is configured by the set of the plurality of main scan line selection signal delivery lines MGL1, /MGL1 to MGLn, /MGLn and the phase difference (the timing difference and the delay difference) of the main scan line selection signals VP1, /VP1 to VPn, /VPn supplied to the set of the plurality of main scan line selection signal delivery lines MGL1, /MGL1 to MGLn, /MGLn is adjusted, such that the writing time necessary for the writing of the data to the pixel circuits PIX(1) to PIX(Q) is freely set. In addition, the reset period can be freely set. Since the parasitic loads of the main scan line selection signal delivery lines MGLn, /MGLn are substantially equal, the selection time of a certain pixel circuit may be set regardless of the distance from the scan line driving circuit 100. Accordingly, accurate control of the selection period (or the reset period) is possible.

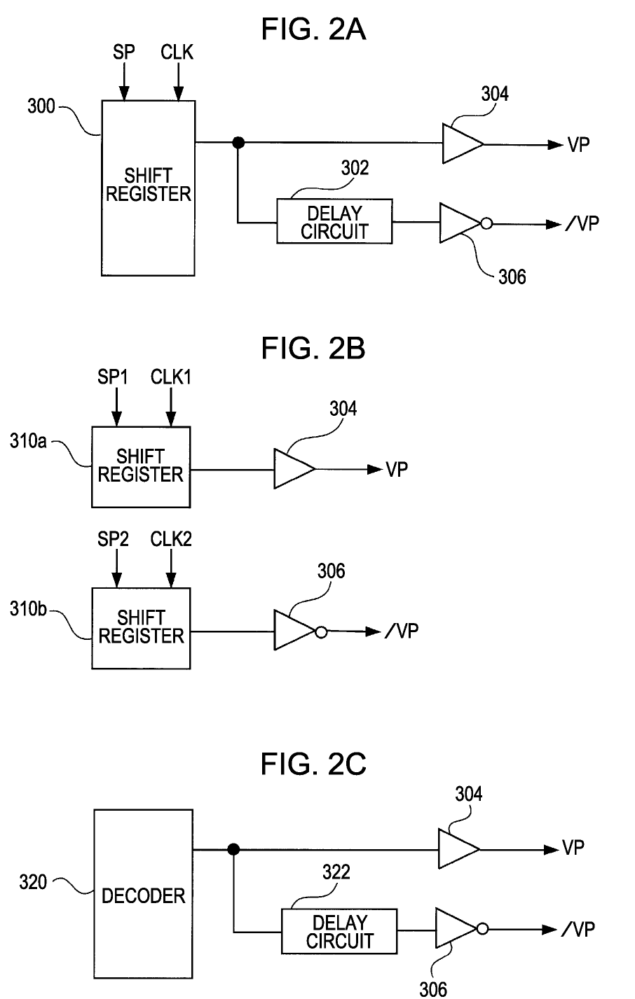

FIGS. 2A to 2C are views explaining a detailed example of the internal configuration of the scan line driving circuit. As described above, the scan line driving circuit 100 needs to generate the main scan line selection signals (for example, MGLn, /MGLn) of which the phase difference is adjusted. In order to adjust the phase difference (the timing difference or the delay difference) of the main scan line selection signals (for example, MGLn, /MGLn), a method of utilizing propagation delay of the logic circuits, a method of utilizing a time constant of RC, or a method of applying a delay timing by an external signal may be employed. In addition, a method of externally setting any delay time may be employed.

In FIG. 2A, one output of one shift register 300 is branched into two signals. One branched signal is output via a positive-phase buffer 304 so as to generate VP (specifically, VP1 to VPn). In addition, the other branched signal is delayed by a delay circuit 302. The voltage level of the output signal of the delay circuit 302 is inverted by an inverter 306 so as to generate /VP (specifically, /VP1 to /VPn).

In FIG. 2B, in order to generate VP (specifically VP1 to VPn) and /VP (specifically /VP1 to /VPn), two shift registers 310a and 310b are provided. The shift register 310a operates using a start pulse SP1 and an operation clock CLK1. The shift register 310b operates using a start pulse SP2 and an operation clock CLK2 (having a predetermined phase difference with respect to CLK1). If the plurality of dedicated shift registers is provided, the phases of the operation clocks for operating the shift registers are delayed by necessary delay time such that the selection times of the pixel circuits necessary for writing the data to the pixel circuits are freely and readily set.

In FIG. 2C, a decoder 320 is used instead of the shift register. The basic configuration is equal to that of FIG. 2A.

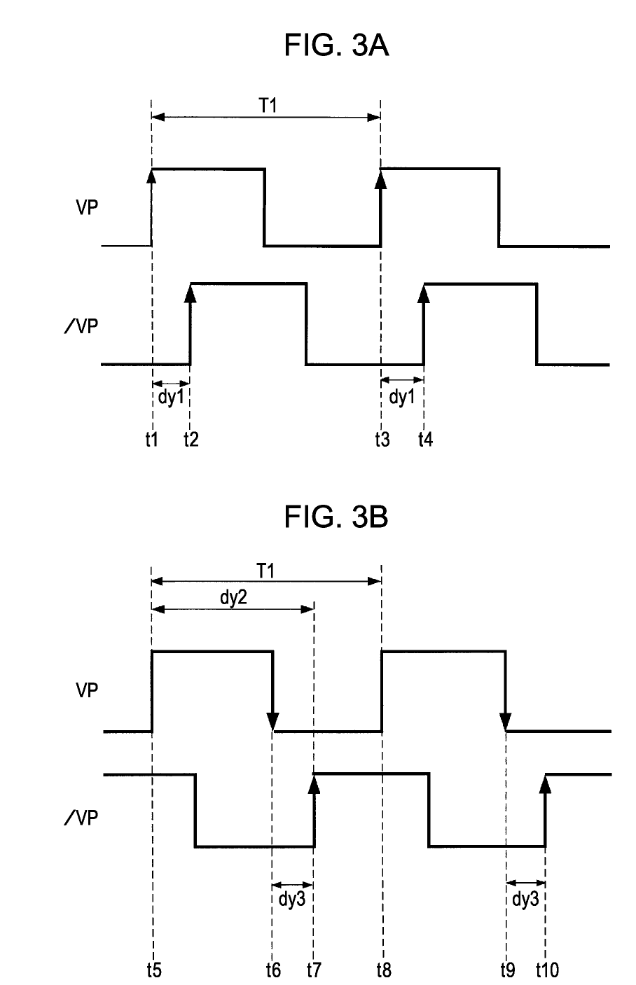

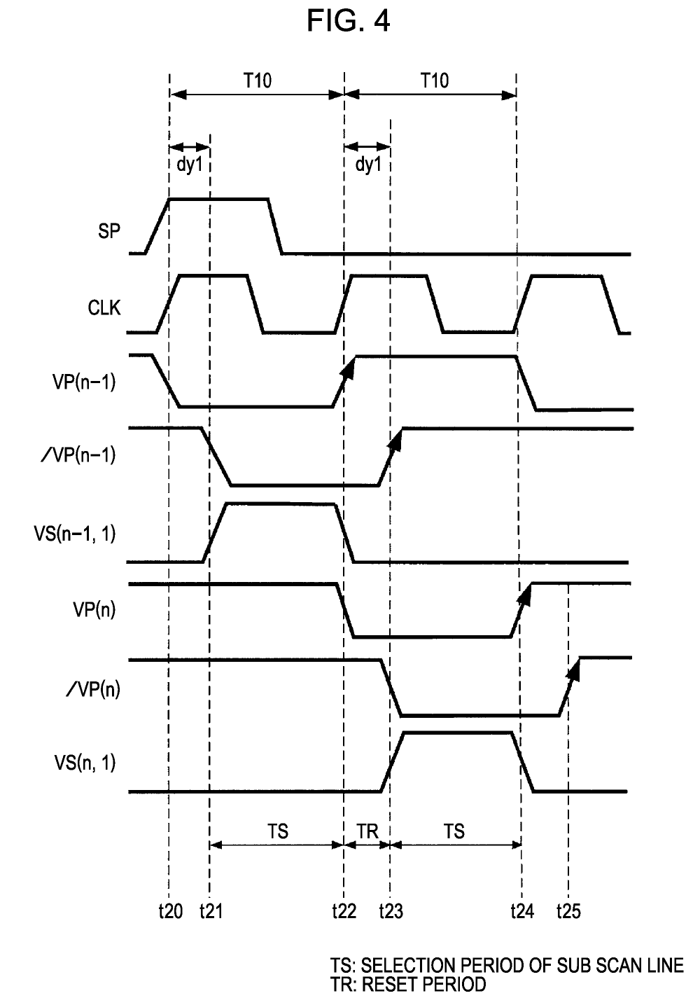

Next, the case where the selection period (the writing period or the reset period) of each of the pixel circuits is controlled using the phase difference between two main scan line selection signals VP, /VP will be described. FIGS. 3A and 3B are views showing the case where a selection period (a writing period or a reset period) of each of the pixel circuits using the phase difference between the two main scan line selection signals VP, /VP. In FIG. 3A, the two main scan line selection signals VP and /VP have a period T1 and a phase difference dy1 therebetween. In this example, the selection period (writing period) of each of the pixel circuits is determined by a timing difference between the positive edges (or the negative edges) of VP and /VP (this will be described with reference to FIG. 4).

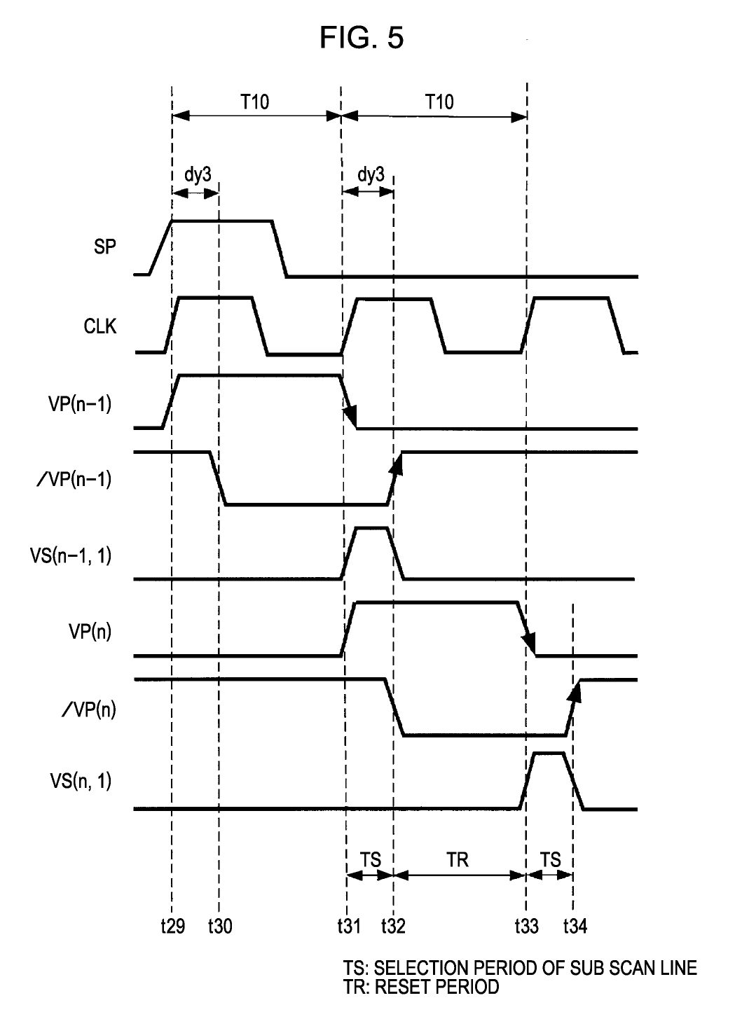

In FIG. 3B, the two main scan line selection signals VP and /VP have a period T1 and a phase difference dy2 therebetween. As the result, the timing difference between the positive edge (the negative edge) of VP and the negative edge (the positive edge) of /VP becomes dy3. In this example, for example, the reset period is determined by a timing difference dy3 between the positive edges of VP and the negative edge of /VP (this will be described with reference to FIG. 5).

FIG. 4 is a waveform diagram showing the waveforms of the main operations when the main scan line selection signals shown in FIG. 3A are used, in the liquid crystal display device of FIG. 1. In FIG. 4, the two-phase main scan line selection signals for driving the set of two main scan line selection signal delivery lines MGL(n−1) and /MGL(n−1) configuring an (n−1)-th row main scan line ML(n−1) are denoted by VP(n−1) and /VP(n−1), and the two-phase main scan line selection signals for driving the set of two main scan line selection signal delivery line MGLn and /MGLn configuring an n-th row main scan line MLn are denoted by VPn and /VPn.

In addition, in FIG. 4, the selection signal of the sub scan line SGL(n−1,1) generated based on VP(n−1) and /VP(n−1) is denoted by VS(n−1,1) and the selection signal of the sub scan line SGL(n,1) generated based on VP(n) and /VP(n) is denoted by VS(n,1).

As shown in FIG. 4, each of VP(n−1), /VP(n−1) and VP(n), /VP(n) is operated in synchronization with the start pulse SP and the operation clock CLK. As described above, the phase difference (timing difference) between VP and /VP is dy1 (see FIG. 3A).

In addition, in FIG. 4, T10 denotes a delay time (fixed value) per delay element of each of the shift registers (for example, the shift registers 310a and 310b of FIG. 2B) mounted in the scan line driving circuit 100.

In addition, as described above, in the liquid crystal display device of FIG. 1, a 2-input NOR gate circuit is used as the logic circuits (G(1,1) to G(n,m)). The 2-input NOR gate circuit outputs “1” when both the two inputs are “0” and, otherwise, always outputs “0”. That is, the selection signal VS of the sub scan line SGL becomes an H level if both VP and /VP are “0” and becomes an L level in the other periods.

Accordingly, a period from a time t21 to a time t22 and a period from a time t23 to a time t24 becomes the selection period TS of the sub scan line (the writing period of the pixel circuit), and a period from a time t22 to a time t23 becomes a reset period TR (a period in which both VP and /VP become the L level and a redundant period for preventing double selection).

As can be seen from FIG. 4, the reset period TS corresponding to the delay time (timing difference) dy1 is automatically inserted. In addition, a period obtained by subtracting the delay time (timing difference) dy1 from the delay time T10 (fixed value) per delay element of the shift register becomes the writing period TS. Accordingly, by adjusting the delay time dy1, the reset period TR and the selection period (writing period) TS are uniquely decided.

FIG. 5 is a waveform diagram showing the waveforms of the main operations when the main scan line selection signals shown in FIG. 3B are used, in the liquid crystal display device of FIG. 1. In FIG. 5, the two-phase main scan line selection signals for driving the set of two main scan line selection signal delivery lines MGL(n−1) and /MGL(n−1) configuring an (n−1)-th row main scan line ML(n−1) are denoted by VP(n−1) and /VP(n−1), and the two-phase main scan line selection signals for driving the set of two main scan line selection signal delivery lines MGLn and /MGLn configuring an n-th row main scan line MLn are denoted by VPn and /VPn.

In addition, in FIG. 5, the selection signal of the sub scan line SGL(n−1,1) generated based on VP(n−1) and /VP(n−1) is denoted by VS(n−1,1) and the selection signal of the sub scan line SGL(n,1) generated based on VP(n) and /VP(n) is denoted by VS(n,1).

As shown in FIG. 5, each of VP(n−1), /VP(n−1) and VP(n), /VP(n) is operated in synchronization with the start pulse SP and the operation clock CLK. As described above, the phase difference (timing difference) between VP and /VP is dy2, and the timing difference between the positive edge of VP and the negative edge of /VP is dy3 (see FIG. 3B).

In addition, as described above, in the liquid crystal display device of FIG. 1, a 2-input NOR gate circuit is used as the logic circuits (G(1,1) to G(n,m)). The 2-input NOR gate circuit outputs “1” when both the two inputs are “0” and, otherwise, always outputs “0”. That is, the selection signal VS of the sub scan line SGL becomes an H level if both VP and /VP are “0” and becomes an L level in the other periods.

Accordingly, a period from a time t31 to a time t32 and a period from a time t33 to a time t34 becomes the selection period TS of the sub scan line (the writing period of the pixel circuit), and a period from a time t32 to a time t33 becomes a reset period TR (a period in which both VP and /VP become the L level and a redundant period for preventing double selection).

As can be seen from FIG. 5, the length of the selection period (the writing period) TS is equal to the timing difference dy3 between the positive edge of VP and the negative edge of /VP. In addition, a period obtained by subtracting the delay time (timing difference) dy3 from the delay time T10 (fixed value) per delay element of the shift register becomes the reset period TR. Accordingly, by adjusting the phase difference dy2 between VP and /VP (that is, by adjusting the delay time dy3), the selection period (writing period) TS and the reset period TR are uniquely decided.

### Second Embodiment

In the present embodiment, the plural kinds of main scan line selection signals (the main scan line selection signals having different timings, that is, the main scan line selection signals having different phase relationships, and more specifically VP and /VPA, VP and /VPB) are prepared as the main scan line selection signals VP and /VP. These main scan line selection signals are selectively used according to the pixel circuits. In the present embodiment, among all the pixel circuits existing in the display area of the liquid crystal display device, for example, a first group is driven at a first timing (a first selection period or a first reset period) and a second group is driven at a second timing (a second selection period or a second reset period) different from the first timing. Accordingly, it is possible to set the writing time to the pixel circuits to an optimal time. Even when the present embodiment is used, the effect described in the first embodiment can be obtained.

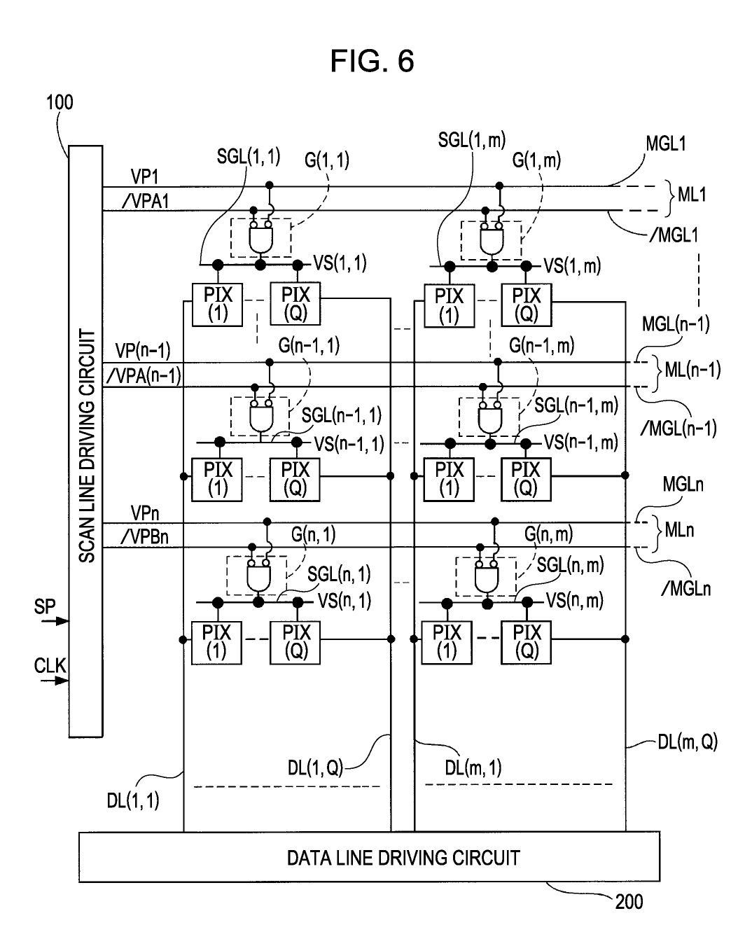

FIG. 6 is a view showing the configuration of another example of the electro-optical device (a liquid crystal display device) of the invention. The configuration of FIG. 6 is substantially equal to the configuration of FIG. 1.

In FIG. 6, with respect to the odd-numbered row main scan lines ML (that is, the main scan line selection signal delivery lines MGL(n−1), /MGL(n−1) if n is an even number of 2 or more), VP and /VPA are used as the main scan line selection signals. In addition, with respect to the even-numbered row main scan lines MGL (that is, the main scan line selection signal delivery lines MGL(n), /MGL(n) if n is an even number of 2 or more), VP and /VPB are used as the main scan line selection signals.

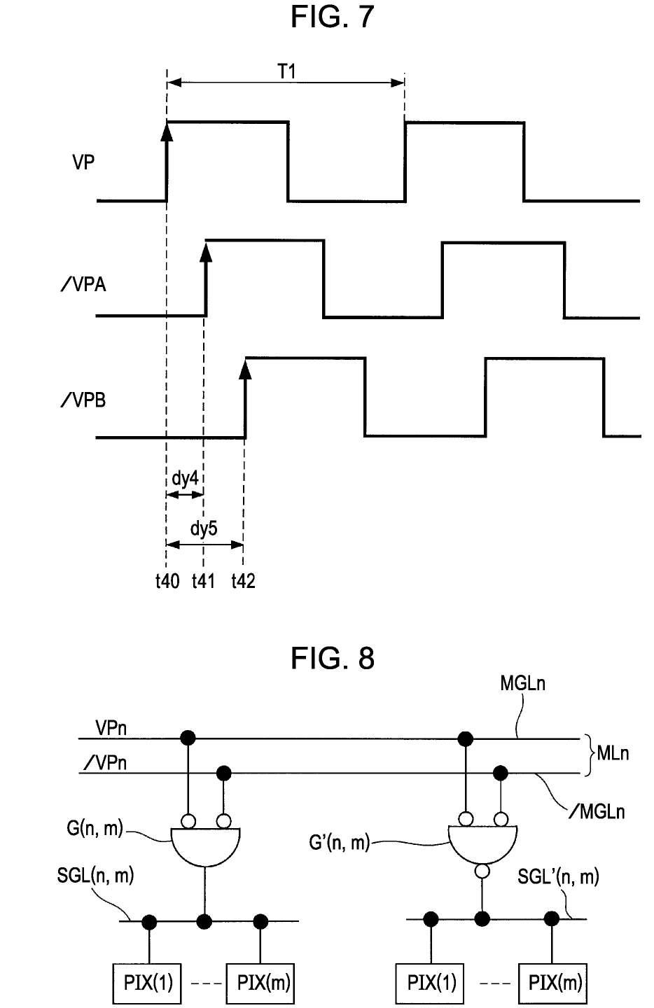

FIG. 7 is a view explaining an example of plural kinds of scan line selection signals used in the circuit of FIG. 6.

A first kind of scan line selection signals includes a first scan line selection signal VP and a second scan line selection signal /VPA. In addition, the second scan line selection signal /VPA has a phase difference (a timing difference or a delay difference) dy4 with respect to the first scan line selection signal VP. Similarly, a second kind of scan line selection signal includes a first scan line selection signal VP and a second scan line selection signal /VPB. In addition, the second scan line selection signal /VPB has a phase difference (a timing difference or a delay difference) dy5 (≠dy4) with respect to the first scan line selection signal VP.

In the present embodiment, among all the pixel circuits existing in the display area of the liquid crystal display device, for example, the first group is driven at the first timing (the first selection period, the first reset period) and the second group is driven at the second timing (the second selection period, the second reset period) different from the first timing. Accordingly, it is possible to set the writing time to the pixel circuits to an optimal time. Even when the present embodiment is used, the effect described in the first embodiment can be obtained.

### Third Embodiment

In the present embodiment, a first kind of logic circuits and a second kind of logic circuits are selectively used. For example, if a positive/negative signal is necessary as a signal supplied to each of the pixel circuits, for example, the output of the logic circuit is inverted by an inverter. That is, if a NOR gate is used as the logic circuit, the NOR gate may be changed to an OR gate with respect to a pixel circuit requiring the negative selection signal.

FIG. 8 is a view explaining an example of selectively using plural kinds of logic circuits. In FIG. 8, the logic circuit G(n,m) is configured by a NOR gate circuit and G′(n,m) is configured by an OR gate circuit. Accordingly, the sub scan line SGL(n,m) and the sub scan line SGL′(n,m) are driven by the sub scan line selection signals having opposite voltage polarities. Accordingly, the complementary signals of H/L may be readily used as the selection signals of the pixel circuits. In addition, in FIG. 8, the plural kinds of logic circuits (for example, a NOR gate and a NAND gate or a logic circuit of a binary output and a logic circuit of a three-valued output) may be selectively used.

### Fourth Embodiment

In the present embodiment, the number of pixel circuits connected to the sub scan line SGL(n,m) is changed according to the distance from the scan line driving circuit 100.

That is, while waveform dullness of the main scan line selection signals VP and /VP of the pixel circuits arranged at a position close to the output terminal of the scan line driving circuit 100 is reduced and a normal timing thereof is maintained, waveform dullness of the main scan line selection signals VP and /VP of the pixel circuits arranged at a position far from the scan line driving circuit is increased by the increase in the length of the main scan line MGL and the load, and a level change timing thereof is delayed relative to the normal timing. That is, strictly speaking, a slight difference occurs between the selection timings (driving timings) of the pixel circuits according to the distance from the scan line driving circuit 100. This timing difference can be reduced by employing a method of changing the number of pixel circuits PIX connected to the sub scan line SGL (or the output terminal of the logic circuit G) according to the distance from the scan line driving circuit 100 (a method of intentionally changing the fan-out of the logic circuit).

In more detail, the number of pixel circuits PIX connected to the sub scan line SGL (short-range scan line) arranged at the position close to the scan line driving circuit 100 is set to be large such that the waveform of the selection signal VS of the sub scan line SGL can become dull to some extent. In contrast, the number of pixel circuits PIX connected to the sub scan line SGL (long-range sub scan line) arranged at the position farther from the scan line driving circuit 100 is set to be smaller such that the waveform dullness of the selection signal VS of the sub scan line SGL can be reduced. That is, if the fan-out number of the logic circuit is reduced, the waveform dullness of the driving signal of the sub scan line is improved. Accordingly, both the pixel circuit arranged at the position close to the scan line driving circuit 100 and the pixel circuit arranged at the position far from the scan line driving circuit 100 can be in the selection/non-selection state at substantially close timings. Accordingly, the display characteristics can be improved.

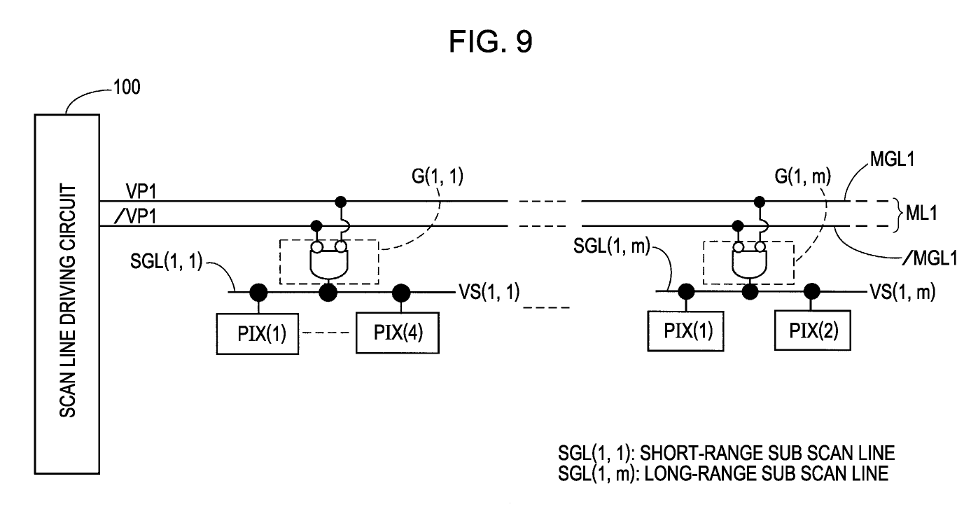

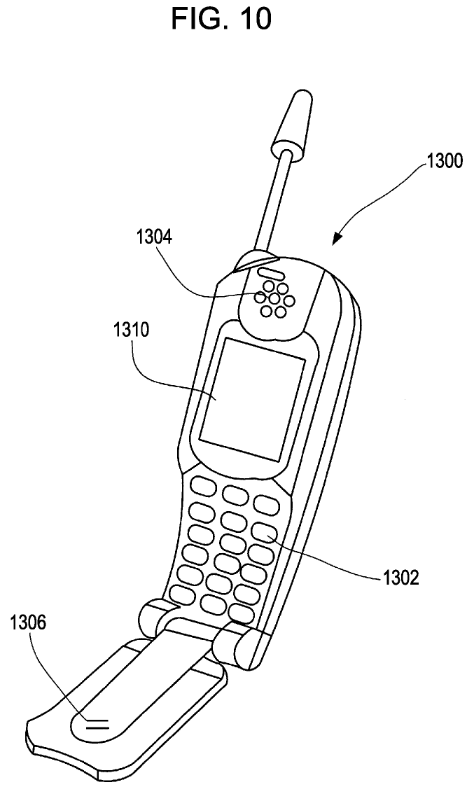

FIG. 9 is a view explaining an example of changing the number of pixel circuits connected to sub scan line according to the distance from the scan line driving circuit. In FIG. 9, the number of pixel circuits PIX connected to the sub scan line (short-range sub scan line) SGL(1,1) that is, the logic circuit G(1,1)) arranged at the position close to the scan line driving circuit 100 is, for example, 4. In contrast, the number of pixel circuits PIX connected to the sub scan line (long-range sub scan line) SGL(1,m) (that is, the logic circuit (G(1,m)) arranged at the position far from the scan line driving circuit 100 is, for example, 2.

This example is only exemplary. In the present embodiment, several variations may be considered. For example, the configuration in which a plurality of sub scan lines connected to one main scan line ML is divided into a plurality of groups according to the distance degree (distance range) from the scan line driving circuit 100 and the number of pixel circuits PIX connected to the sub scan line is changed per group (the number of pixel circuits is reduced as the distance is increased) may be employed.

### Fifth Embodiment

FIG. 10 is a perspective view showing the appearance of an example (mobile telephone) of an electronic apparatus including the liquid crystal display device of the invention.

In FIG. 10, the mobile telephone 1300 includes a liquid crystal display device (a liquid crystal panel) 1310, an operation key 1302, a sound output unit 1304, and a sound input unit 1306.

As described above, the liquid crystal display device 1310 of the invention can realize high-quality display because the display characteristics are improved by the layering of the scan lines. Accordingly, the display performance of the electronic apparatus (that is, the mobile telephone) 1300 having the liquid crystal display device 1310 mounted therein is also improved.

The invention is applicable to various electronic apparatuses in addition to the mobile telephone. For example, the invention is applicable to a reflective projector or an illumination device.

According to several embodiments of the invention, for example, an influence of the change in the potential of the data line due to the writing to the selection pixel on the non-selection pixel is minimized and thus the display characteristics of the non-selection pixel can be significantly improved.

As described above, according to several embodiments of the invention, for example, the following effects can be obtained. The following effects are not limited to be simultaneously obtained and the following effects should not be used as references for wrongly restricting the technical range of the invention.

(1) Since the scan lines are layered such that the main scan lines and the sub scan lines are provided and the logic circuits having the waveform shaping function are provided between the both lines, it is possible to prevent malfunction of the pixel circuits. That is, although the signal waveform becomes dull in the portions of the scan line selection signal delivery lines located before the logic circuits, the waveform shaping is performed in the output portions of the logic circuits and thus signals close to rectangular signals are given to the pixel circuits. Since the signals close to the rectangular signals are given to the pixel circuits, for example, it is possible to prevent the malfunction of the flip-flop circuits in the pixels. In addition, it is possible to reduce through-current in an inverter circuit portion.

(2) Since the main scan lines are configured by the plurality of main scan line selection signal delivery lines and the phase difference (the timing difference or the delay difference) of the main scan line selection signals supplied to the plurality of main scan line selection signal delivery lines are adjusted, a writing time necessary for writing data to the pixel circuits are freely set. In addition, the reset period can be freely set. Since the parasitic loads of the main scan line selection signal delivery lines are substantially equal, the selection time of a certain pixel circuit may be set regardless of the distance from the scan line driving circuit. Accordingly, accurate control of the selection period (or the reset period) is possible.

(3) The operation timing of the selection signal of each of the sub scan lines for setting the pixel circuits to a selection/non-selection state is determined by the rising or falling timing of each of the main scan line selection signals. By adjusting the phase difference between the main scan line selection signals, it is possible to freely control the timing. Accordingly, it is possible to freely set the reset period. In addition, it is easy to set setup/hold time of the written data to each of the pixel circuits. Since each of the pixel circuits is in the non-selection state at a timing excluding the rising or falling timing of each of the main scan line selection signals, it is difficult to perform the operation, such as rewriting, by the pixel circuits several times due to unnecessary data.

(4) In order to adjust the phase difference (the timing difference or the delay difference) of the main scan line selection signals, a method of utilizing propagation delay of the logic circuits, a method of utilizing a time constant of RC, or a method of applying a delay timing by an external signal may be employed. In addition, a method of externally setting any delay time may be employed. If the plurality of dedicated shift register circuits is provided in order to generate the scan line selection signals supplied to the plurality of scan line selection signal delivery lines, the phases of the operation clocks for operating the shift register circuits are delayed by necessary delay time such that the selection times of the pixel circuits necessary for writing the data to the pixel circuits are freely and readily set.

(5) Since the plurality (2 or more) of pixel circuits is connected to the sub scan lines selected by the outputs of the logic circuits, the load of each of the scan lines is reduced from the viewpoint of the scan line driving circuit. That is, the plurality of pixels is connected to each of the scan lines in the related art. Accordingly, from the viewpoint of the scan line driving circuit, the pixels function as the load. In contrast, in the present embodiment, since the logic circuits are provided, the logic circuits function as the load from the viewpoint of the scan line driving circuit. If the plurality (w) of pixels is driven by the logic circuits, the load is reduced to 1/w by simple computation from the viewpoint of the scan line driving circuit. Accordingly, it is possible to realize the high-speed frequency (rising speed and falling speed) of each of the main scan line selection signals. In addition, in the scan line driving circuit, since the reset period does not need to be inserted into each of the scan line selection signals, it is possible to realize higher-speed scan line driving.

(6) Since the internal load of the scan line driving circuit is not increased, the charging/discharging current of the scan line driving circuit portion is reduced and thus power consumption is reduced.

(7) The plural kinds of main scan line selection signals (the main scan line selection signals having different timings) are prepared as the main scan line selection signals. These main scan line selection signals are selectively used according to the pixel circuits. In this case, among all the pixel circuits existing in the display area of the liquid crystal display device, for example, the first group is driven at the first timing (the first selection period or the first reset period) and the second group is driven at the second timing (the second selection period or the second reset period) different from the first timing. Accordingly, it is possible to set the writing time to the pixel circuits to an optimal time. Even when the present embodiment is used, the above-described effect can be obtained.

(8) If the positive/negative signal is necessary as the signal supplied to each of the pixel circuits, for example, the output of the logic circuit is inverted by an inverter. Accordingly, the complementary signals of H/L may be readily used as the selection signals of the pixel circuits.

(9) While waveform dullness of the main scan line selection signals of the pixel circuits arranged at the position close to the output terminal of the scan line driving circuit is reduced and a normal timing thereof is maintained, waveform dullness of the main scan line selection signals of the pixel circuits arranged at the position far from the scan line driving circuit is increased by the increase in the length of the main scan line and the load and a level change timing thereof is delayed relative to the normal timing. That is, a difference occurs between the selection timings (driving timings) of the pixel circuits according to the distance from the scan line driving circuit. This timing difference can be reduced by employing a method of changing the number of pixel circuits connected to the logic circuit according to the distance from the scan line driving circuit (a method of intentionally changing the fan-out of the logic circuit). That is, the number of pixel circuits connected to the logic circuit arranged at the position close to the scan line driving circuit is set to be large such that the waveform of the selection signal of the sub scan line can become dull to some extent. In contrast, the number of pixel circuits connected to the logic circuit arranged at the position far from the scan line driving circuit is set to be small such that the waveform dullness of the selection signal of the sub scan line can be reduced. Accordingly, both the pixel circuit arranged at the position close to the scan line driving circuit and the pixel circuit arranged at the position far from the scan line driving circuit can be in the selection/non-selection state at substantially close timings. Accordingly, the display characteristics can be improved.

Although the embodiments of the invention are described, it will be understood by those skilled in the art that various modifications can be made without departing from the novel matters and effects of the invention. Accordingly, all these modifications are included in the invention. The invention is applicable to various kinds of electro-optical devices (a liquid crystal display device, an organic electroluminescence (EL) display device and other display devices) and various kinds of electronic apparatuses.

The entire disclosure of Japanese Patent Application No: 2008-044546, filed Feb. 26, 2008 is expressly incorporated by reference herein.

What is claimed is:

1. An electro-optical device comprising:
n (n is an integer of 2 or more) main scan lines;
m (m is an integer of 1 or more) sub scan lines provided in correspondence with a k-th main scan line (1≦k≦n) of the n main scan lines;
m logic circuits provided between the k-th main scan line and the m sub scan lines;
a plurality of pixel circuits respectively connected to the m sub scan lines; and
a scan line driving circuit selecting the n main scan lines,
wherein the k-th main scan line has a set of x (x is an integer of 2 or more) main scan line selection signal delivery lines,
each of the set of x main scan line selection signal delivery lines configuring the k-th main scan line is selected by each of first to x-th main scan line selection signals having the same period and different phases and output from the scan line driving circuit, and
each of the m logic circuits has x input nodes, each of the x input nodes is connected to each of the set of x main scan line selection signal delivery lines, and each of the m sub scan lines is selected on the basis of each of the output signals of the m logic circuits.

2. The electro-optical device according to claim 1, wherein the scan line driving circuit line-sequentially drives the n main scan lines without using a circuit for preventing simultaneous selection of adjacent main scan lines.

3. The electro-optical device according to claim 1, wherein:
when the k-th main scan line and a (k+1)-th main scan line are line-sequentially driven, between a selection period of a p^{th} (1≦p≦m) of the m sub scan lines corresponding to the k-th main scan line and a selection period of a q-th (1≦q≦m) of the m sub scan lines corresponding to the (k+1)-th main scan line, a reset period in which both the p-th sub scan line and the q-th sub scan line become a non-selection level is provided, and
the length of the reset period or the selection period of the sub scan line is determined by a phase difference between each of the second to x-th main scan line selection signals and the first main scan line selection signal among the first to x-th main scan line selection signals.

4. The electro-optical device according to claim 1, wherein:
when a phase difference relationship between each of the second to x-th main scan line selection signals and the first main scan line selection signal among the first to x-th main scan line selection signals of the k-th main scan line is a first phase difference relationship and a phase difference relationship between each of the second to x-th main scan line selection signals and the first main scan line selection signal among the first to x-th main scan line selection signals of an r-th (1≦r≦n and r≠k) main scan line is a second phase difference relationship,
the scan line driving circuit generates the first to x-th main scan line selection signals of the k-th main scan line and the first to x-th main scan line selection signals of the r-th main scan line such that the first phase difference relationship and the second phase difference relationship are different from each other.

5. The electro-optical device according to claim 1, wherein the plurality of logic circuits connected to each of the n main scan lines includes a first kind of logic circuits which performs a first logic operation and a second kind of logic circuit which performs a second logic operation which is an inverted logic operation of the first logic operation.

6. The electro-optical device according to claim 1, wherein:
when at least one sub scan line close to the scan line driving circuit is a short-range sub scan line and at least one sub scan line farther from the scan line driving circuit than the short-range sub scan line is a long-range sub scan line, among the m sub scan lines provided in correspondence with the k-th main scan line (1≦k≦n),
i (i is an integer of 3 or more) pixel circuits are connected to the short-range sub scan line and j (j is an integer of 2 or more and j<i) pixel circuits are connected to the long-range sub scan line.

7. The electro-optical device according to claim 1, wherein:
the scan line driving circuit has first to x-th shift registers which generate the first to x-th main scan line selection signals having the same period and the different phases, and
the first to x-th shift registers operate by operation clocks having different phases.

8. A method of driving an electro-optical device including n (n is an integer of 2 or more) main scan lines, m (m is an integer of 1 or more) sub scan lines provided in correspondence with a k-th main scan line (1≦k≦n) of the n main scan lines, m logic circuits provided between the k-th main scan line and the m sub scan lines, a plurality of pixel circuits respectively connected to the m sub scan lines, and a scan line driving circuit selecting the n main scan lines, wherein the k-th main scan lines has a set of x (x is an integer of 2 or more) main scan line selection signal delivery lines, and each of the m logic circuits has x input nodes, each of the x input nodes is connected to each of the set of x main scan line selection signal delivery lines, and each of the m sub scan lines is selected on the basis of each of the output signals of the m logic circuits,
wherein each of the set of x main scan line selection signal delivery lines configuring the k-th main scan line is selected by each of first to x-th main scan line selection signals having the same period and different phases and output from the scan line driving circuit.

9. An electronic apparatus comprising the electro-optical device according to claim 1.
